(19) United States
(12) Patent Application Publication
(10) Pub. No.: US 2015/0140248 A1
(43) Pub. Date: May 21, 2015

(54) Polycarbonate Resin Composition and Molded Article Including the Same

(71) Applicant: Samsung SDI Co., Ltd., Yongin-si (KR)

(72) Inventors: Ha Na RA, Uiwang-si (KR); Yong Tae KIM, Uiwang-si (KR); Su Hak BAE, Uiwang-si (KR); Sung Hee AHN, Uiwang-si (KR); Ji Hye LEE, Uiwang-si (KR); Hyun Ho LEE, Uiwang-si (KR); Hyun Joo HAN, Uiwang-si (KR)

(21) Appl. No.: 14/521,764

(22) Filed: Oct. 23, 2014

(30) Foreign Application Priority Data
Nov. 19, 2013 (KR) 10-2013-0140400
Jul. 30, 2014 (KR) 10-2014-0097661

(51) Int. Cl. C08K 5/5419; C08K 3/34; C08K 3/18; C08K 5/42

(52) U.S. Cl. CPC C08K 5/5419; C08K 5/42; C08K 3/34; C08K 3/18
USPC 428/36.92; 524/161

(57) ABSTRACT

A polycarbonate resin composition includes: a polycarbonate resin; inorganic fillers including flake and acicular fillers; and a sulfonate represented by Formula 1, wherein the sulfonate is present in an amount of about 0.1 parts by weight to about 1.0 part by weight based on about 100 parts by weight of the polycarbonate resin. The polycarbonate resin composition can exhibit excellent stiffness, excellent impact resistance, excellent property balance therebetween, and the like.

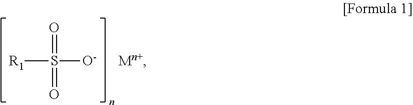

wherein R₁ is a C₆ to C₃₀ hydrocarbon group; M is an alkali or alkali earth metal; and n is 1 or 2.

### CROSS-REFERENCE TO RELATED APPLICATION

This application claims priority under 35 USC Section 119 to and the benefit of Korean Patent Application 10-2013-0140400, filed Nov. 19, 2013, and Korean Patent Application No. 10-2014-0097661, filed Jul. 30, 2014, the entire disclosure of each of which is incorporated herein by reference.

### FIELD OF THE INVENTION

The present invention relates to a polycarbonate resin composition and a molded article including the same.

### BACKGROUND

If a thermoplastic or thermosetting resin is blended with inorganic fillers such as glass fibers, silica, talc and the like, the resin can exhibit improved stiffness, such as tear strength, tensile strength, flexural strength, flexural modulus and the like, due to inherent properties of the inorganic fillers. Typically, blends of the thermoplastic resin such as polycarbonates with the inorganic fillers are used for molded articles requiring high stiffness, and widely used particularly for interior/exterior materials of automobiles and electronics.

However, when the thermoplastic resin is blended with the inorganic fillers, the thermoplastic resin can suffer from deterioration in fluidity (moldability) and deterioration in appearance, such as protrusion of the inorganic fillers from a surface of a molded article, and the like. To solve such problems, a material capable of controlling interface properties between the thermoplastic resin and the fillers are typically used. Such materials include surfactants, coupling agents and the like, and the interface properties can be controlled in a manner in which one side of the material acts on the thermoplastic resin and the other side thereof acts on the fillers. If the interface properties are controlled, the resin can exhibit improved impact strength, fluidity, and the like.

US Patent Publication No. 2012-0245262 discloses a polycarbonate composition using a sulfonate and inorganic fillers to improve impact properties thereof. EP 1860145 discloses a polysulfone composition using fibrous (acicular) fillers and a sulfonate to improve impact properties thereof.

As such, although the thermoplastic resin can exhibit improved stiffness, impact resistance and the like using the inorganic fillers, the coupling agent and the like, an excess of inorganic fillers can cause the resin to be easily broken at room temperature and provides a difficulty in preventing deterioration in elongation, fluidity and the like. In addition, it is difficult to improve stiffness of the resin despite use of the coupling agent and a compatibilizer, unlike properties such as impact resistance, fluidity and the like.

Therefore, there is a need for a polycarbonate resin composition that exhibits excellent stiffness, excellent impact resistance, excellent property balance therebetween, and the like.

### SUMMARY

Exemplary embodiments of the present invention provide a polycarbonate resin composition which can exhibit excellent stiffness, impact resistance, property balance therebetween and the like, and a molded article including the resin composition.

The polycarbonate resin composition includes: a polycarbonate resin; inorganic fillers including flake and acicular fillers; and a sulfonate represented by Formula 1, wherein the sulfonate is present in an amount of about 0.1 parts by weight to about 1.0 part by weight based on about 100 parts by weight of the polycarbonate resin.

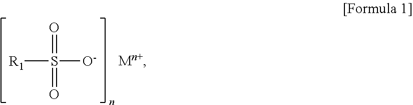

wherein R₁ is a C₆ to C₃₀ hydrocarbon group; M is an alkali or alkali earth metal; and n is 1 or 2.

In one embodiment, R₁ may be a C₁₂ to C₁₈ hydrocarbon group and M may be sodium (Na) or calcium (Ca).

In one embodiment, the flake fillers may include talc, mica, or a mixture thereof; and the acicular fillers may include wollastonite, whiskers, glass fibers, basalt fibers, or a mixture thereof.

In one embodiment, the flake fillers may have an average thickness from about 30 nm to about 700 nm, an average particle size from about 0.65 μm to about 5.0 μm, and a ratio of average diameter to average thickness (diameter/thickness) from about 4 to about 30; and the acicular fillers may have an average diameter (D) from about 0.3 μm to about 15 μm, an average length (L) from about 3 μm to about 3,000 μm, and a ratio of the average length to the average diameter (L/D) from about 10 to about 200.

In one embodiment, the inorganic fillers may be present in an amount of about 1 part by weight to about 80 parts by weight based on about 100 parts by weight of the polycarbonate resin.

In one embodiment, the flake fillers may be present in an amount of about 1% by weight (wt %) to about 99 wt % based on a total amount of the inorganic fillers, and the acicular fillers may be present in an amount of about 1 wt % to about 99 wt % based on the total amount of the inorganic fillers.

In one embodiment, a weight ratio of flake fillers to acicular fillers (flake fillers:acicular fillers) may range from about 1:1 to about 1:2.

In one embodiment, the polycarbonate resin composition may further include about 0.1 parts by weight to about 1.0 part by weight of a silane coupling agent based on about 100 parts by weight of the polycarbonate resin.

In one embodiment, the silane coupling agent may be represented by Formula 2:

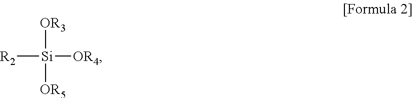

wherein R₂ is a C₆ to C₃₀ alkyl group, and R₃, R₄ and R₅ are the same or different and are each independently a C₁ to C₅ alkyl group.

In one embodiment, a content (weight) ratio of the sulfonate to the silane coupling agent (weight ratio, sulfonate:silane coupling agent) may range from about 0.5:1 to about 1.5:1.

In one embodiment, the polycarbonate resin composition may further include at least one of flame retardants, flame retardant aids, lubricants, plasticizers, heat stabilizers, anti-dripping agents, antioxidants, photostabilizers, pigments, and dyes.

In one embodiment, the polycarbonate resin composition may have an Izod impact strength from about 5 kgf·cm/cm to about 16 kgf·cm/cm, as measured on an about ⅛″ thick specimen in accordance with ASTM D256, and a falling dart impact (FDI) strength from about 15 J to about 60 J, as measured on an about 3.2 mm thick specimen in accordance with the Dupont drop measurement method.

In one embodiment, the polycarbonate resin composition may have a deformation length of 16 mm or less, as measured on an injection-molded specimen having a size of about 50 mm×about 200 mm×about 1 mm after a force of about 10 kgf is applied to a center of the injection-molded specimen for about 1 minute using the same analyzer as a flexural strength measuring apparatus in accordance with ASTM D790.

The present invention also relates to a molded article formed from a polycarbonate resin composition.

In one embodiment, the molded article may be an electronics housing having a thickness from about 0.4 mm to about 3.0 mm.

### DETAILED DESCRIPTION

Exemplary embodiments now will be described more fully hereinafter in the following detailed description, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

According to the present invention, a polycarbonate resin composition, which can exhibit improved stiffness and impact resistance, includes: a polycarbonate resin; inorganic fillers including flake and acicular fillers; and a sulfonate.

According to the present invention, the polycarbonate resin is a typical thermoplastic polycarbonate resin. For example, the polycarbonate resin may be an aromatic polycarbonate resin prepared by reacting one or more diphenols (aromatic diol compounds) with a precursor such as phosgene, halogen formates, carbonic acid diesters, and the like.

Examples of diphenols may include without limitation 4,4′-biphenol, 2,2-bis(4-hydroxyphenyl)propane, 2,4-bis(4-hydroxyphenyl)-2-methylbutane, 1,1-bis(4-hydroxyphenyl)cyclohexane, 2,2-bis(3-chloro-4-hydroxyphenyl)propane, 2,2-bis(3,5-dichloro-4-hydroxyphenyl)propane, and the like, and combinations thereof. For example, the diphenol may include 2,2-bis(4-hydroxyphenyl)propane, 2,2-bis(3,5-dichloro-4-hydroxyphenyl)propane, and/or 1,1-bis(4-hydroxyphenyl)cyclohexane, for example 2,2-bis(4-hydroxyphenyl)propane, which is also referred to as bisphenol-A.

The polycarbonate resin may be a branched polycarbonate resin and may be prepared by, for example, reacting about 0.05 mol % to about 2 mol % of a polyfunctional compound containing tri- or higher functional groups, for example, tri- or higher-valent phenol groups, based on the total amount of diphenols used in polymerization.

The polycarbonate resin may be used in the form of a homo-polycarbonate resin, a co-polycarbonate resin, or blends thereof.

In addition, the polycarbonate resin may be partially or completely replaced by an aromatic polyester-carbonate resin obtained by polymerization in the presence of an ester precursor, for example, a bifunctional carboxylic acid.

The polycarbonate resin may have a weight average molecular weight (Mw) from about 10,000 g/mol to about 200,000 g/mol, for example, from about 15,000 g/mol to about 40,000 g/mol, without being limited thereto.

According to the present invention, the inorganic fillers include both the flake fillers and the acicular filler. Examples of the flake fillers may include talc, mica, and the like, and mixtures thereof, for example, talc, without being limited thereto. Examples of the acicular fillers may include wollastonite, whiskers, glass fibers, basalt fibers, and the like, and mixtures thereof, for example, wollastonite and whiskers, without being limited thereto.

In one embodiment, examples of the whiskers may include without limitation potassium titanate whiskers, magnesium sulfate whiskers, calcium carbonate whiskers, aluminum borate whiskers, and the like, and mixtures thereof. In addition, the glass fibers may include a glass fiber reinforcing agent in which fibers are formed by bundling glass filaments coated with a sizing agent, such as epoxy, urethane, and/or silane, without being limited thereto. Herein, the sizing agent may be present in an amount of about 0.05 parts by weight to about 2.0 parts by weight based on about 100 parts by weight of the glass filaments, without being limited thereto.

In one embodiment, the flake fillers have a thin film shape having a small z-axis length (thickness) as compared with a sectional area formed by x-axis and y-axis lengths. In addition, the flake fillers may have an average thickness from about 30 nm to about 700 nm, for example, from about 30 nm to about 300 nm, and as another example from about 32 nm to about 270 nm; an average particle size from about 0.65 μm to about 5.0 μm, for example, from about 0.65 μm to about 2.7 μm, and as another example from about 0.8 μm to about 2.5 μm; and a ratio of an average diameter (average x-axis and y-axis lengths) to the average thickness (z-axis length) (aspect ratio, diameter/thickness) from about 4 to about 30, for example, from about 10 to about 30. As the ratio of the average diameter to average thickness increases, stiffness of the polycarbonate resin composition improves.

For reference, the average particle size of the flake fillers refers to a median value of particle size distribution measured by X-ray transmission. Specifically, the particle size distribution of the flake fillers are obtained by X-ray transmission of sinking particles, followed by calculating the median value, thereby obtaining the average particle size.

In addition, the acicular fillers have an acicular (fibrous) shape, and may have an average diameter (D) from about 0.3 μm to about 15 μm, for example, from about 0.5 μm to about 13 μm, an average length (L) from about 3 μm to about 3,000 μm, for example, from about 5 μm to about 2,600 μm, and a ratio of the average length to the average diameter (aspect ratio, L/D) from about 10 to about 200, for example, from about 20 to about 100.

Within this range, the polycarbonate resin composition can exhibit shrinkage stability and high stiffness due to mixing of the flake fillers and the acicular fillers.

In one embodiment, the flake fillers may be present in an amount of about 1 wt % to about 99 wt %, for example, about 10 wt % to about 70 wt %, and as another example about 10 wt % to about 60 wt % based on the total amount (total weight, 100 wt %) of the inorganic fillers. In some embodiments, the flake fillers may be present in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the flake fillers can be in a range from about any of the foregoing amounts to about any other of the foregoing amounts.

In addition, the acicular fillers may be present in an amount of about 1 wt % to about 99 wt %, for example, about 30 wt % to about 90 wt %, and as another example about 40 wt % to about 90 wt % based on a total amount (total weight, 100 wt %) of the inorganic fillers. In some embodiments, the acicular fillers may be present in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the acicular fillers can be in a range from about any of the foregoing amounts to about any other of the foregoing amounts.

When the inorganic filler includes the flake filler and the acicular filler in amounts within the above ranges, the polycarbonate resin composition can exhibit excellent impact resistance and stiffness.

In one embodiment, a weight ratio of flake fillers to acicular fillers (flake fillers:acicular fillers) may range from about 1:1 to about 1:2, for example, from about 1:1.5 to about 1:1.9. Within this range, the polycarbonate resin composition can exhibit superior impact resistance and stiffness.

As such, the mixed flake and acicular fillers may be identified through analysis of the polycarbonate resin composition (pellet) by transmission electron microscopy and scanning electron microscopy. When a pellet is cut and observed using a transmission electron microscope, various shapes of the flake fillers, such as a circular shape, an elliptical shape, and a bar shape, can be identified. In addition, when a tensile specimen is cut and observed using a scanning electron microscope, the presence of the acicular fillers, which have a relatively high length/diameter ratio, can be identified.

The polycarbonate resin composition may include the inorganic fillers in an amount of about 1 part by weight to about 80 parts by weight, for example, about 5 parts by weight to about 50 parts by weight, and as another example about 10 parts by weight to about 40 parts by weight, based on about 100 parts by weight of the polycarbonate resin. In some embodiments, the polycarbonate resin composition may include the inorganic fillers in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 parts by weight. Further, according to some embodiments of the present invention, the amount of the inorganic fillers can be in a range from about any of the foregoing amounts to about any other of the foregoing amounts.

Within this range, the polycarbonate resin composition can exhibit excellent impact resistance and stiffness with minimal or no deterioration in fluidity thereof.

According to the present invention, the sulfonate serves to control interface properties between the inorganic fillers and the resin and disperse the fillers in the resin, and may be represented by Formula 1:

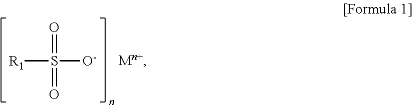

wherein R₁ may be a C₆ to C₃₀ hydrocarbon group, for example, a C₆ to C₂₀ alkyl group or a C₇ to C₃₀ arylalkyl group, for example a C₁₂ to C₁₈ hydrocarbon group (C₁₂ to Cis alkyl group, C₁₂ to C₁₈ arylalkyl group, and the like); M is an alkali or alkali earth metal element, for example, sodium (Na), magnesium (Mg) or calcium (Ca), for example sodium (Na) or calcium (Ca); and n is 1 or 2, for example, 1 when M is an alkali metal, and 2 when M is an alkali earth metal.

Examples of the sulfonate may include sodium dodecylbenzenesulfonate, calcium dodecylbenzenesulfonate, and the like, and mixtures thereof, without being limited thereto.

The polycarbonate resin composition may include the sulfonate in an amount of about 0.1 parts by weight to about 1.0 part by weight, for example, about 0.3 parts by weight to about 0.7 parts by weight, based on about 100 parts by weight of the polycarbonate resin. In some embodiments, the polycarbonate resin composition may include the sulfonate in an amount of about 0.1, 0.2, 0.3, 0.4, 0.5, 0.6, 0.7, 0.8, 0.9, or 1 part by weight. Further, according to some embodiments of the present invention, the amount of the sulfonate can be in a range from about any of the foregoing amounts to about any other of the foregoing amounts.

Within this range, the polycarbonate resin composition can exhibit excellent impact resistance and stiffness, and gas generation in a gate surrounding portion upon injection molding of the composition can be reduced or prevented, thereby improving appearance of a specimen.

According to the present invention, the polycarbonate resin composition may further include a silane coupling agent to improve interface adhesion between the polycarbonate resin and the inorganic fillers and to improve stiffness thereof. The silane coupling agent may be a silane coupling agent used for typical polycarbonate resin compositions. For example, the silane coupling agent may be represented by Formula 2:

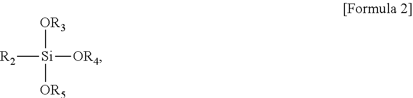

wherein R₂ is a C₆ to C₃₀ alkyl group, and R₃, R₄ and R₅ are the same or different and are each independently a C₁ to C₅ alkyl group.

Examples of the silane coupling agent may include decyltrimethoxysilane, heptyltrimethoxysilane, heptyltriethoxysilane, octyltrimethoxysilane, octyltriethoxysilane, dodecyltrimethoxysilane, dodecyltriethoxysilane, hexadecyltrimethoxysilane, hexadecyltriethoxysilane, octadecyltrimethoxysilane, octadecyltriethoxysilane, and the like, and mixtures thereof, without being limited thereto.

The polycarbonate resin composition may include the silane coupling agent in an amount of about 0.1 parts by weight to about 1.0 part by weight, for example, about 0.3 parts by weight to about 0.7 parts by weight, based on about 100 parts by weight of the polycarbonate resin. In some embodiments, the polycarbonate resin composition may include the silane coupling agent in an amount of about 0.1, 0.2, 0.3, 0.4, 0.5, 0.6, 0.7, 0.8, 0.9, or 1 part by weight. Further, according to some embodiments of the present invention, the amount of the silane coupling agent can be in a range from about any of the foregoing amounts to about any other of the foregoing amounts.

Within this range, the polycarbonate resin composition can have improved adhesion, stiffness and the like, and can exhibit excellent impact resistance and stiffness.

In one embodiment, a content ratio of the sulfonate to the silane coupling agent (weight ratio, sulfonate: silane coupling agent) may range from about 0.5:1 to about 1.5:1, for example, from about 0.8:1 to about 1.2:1, and as another example from about 0.9:1 to about 1.1:1. Within this range, gas generation in the gate surrounding portion upon injection molding of the composition can be further reduced or prevented, and appearance of the specimen can be improved.

According to the present invention, the polycarbonate resin composition may further include one or more additives, such as without limitation flame retardants, flame retardant aids, lubricants, plasticizers, heat stabilizers, anti-dripping agents, antioxidants (oxidation stabilizers), photostabilizers, pigments, dyes, and the like, as needed. These additives may be used alone or in combination thereof. The additives may be any additive used for typical polycarbonate resin compositions. For example, the additives may include phosphorus flame retardants such as sodium pyrophosphate, resorcinol bis(di-2,6-dimethylphenyl)phosphate, and the like; antioxidants such as hindered phenol compounds; and mixtures thereof, without being limited thereto.

In one embodiment, the additives may be present in an amount of about 0.1 parts by weight to about 10 parts by weight based on about 100 parts by weight of the polycarbonate resin, without being limited thereto.

According to the present invention, the polycarbonate resin composition may be prepared in pellet form by mixing the above components, followed by melt extrusion at about 200° C. to about 280° C., for example, about 250° C. to about 260° C., using a typical twin-screw extruder.

The pellets may be formed into various molded articles through various molding methods, such as injection molding, extrusion, vacuum molding, cast molding, and the like. These molding methods are well known by those of ordinary skill in the art.

In one embodiment, the polycarbonate resin composition according to the present invention may have an Izod impact strength from about 5 kgf·cm/cm to about 16 kgf·cm/cm, for example, from about 7 kgf·cm/cm to about 12 kgf·cm/cm, as measured on an about ⅛″ thick specimen in accordance with ASTM D256.

The polycarbonate resin composition may have a falling dart impact (FDI) strength (crack generation energy) from about 15 J to about 60 J, for example, from about 25 J to about 50 J, as measured on an about 1 mm thick specimen (about 10 cm×about 10 cm×about 1 mm) using an about 2 kg dart in accordance with the Dupont drop measurement method, in which a maximum height not generating a crack is measured by adjusting a height of the dart, followed by converting the maximum height into potential energy. Here, the maximum height not generating a crack is obtained in such a manner that a dart having a certain weight is dropped onto the about 1 mm thick specimen from a varying height, followed by observing generation of cracks in the specimen by the naked eye.

In addition, to measure stiffness of the polycarbonate resin composition, a pressure deformation test is performed. The pressure deformation test refers to a test in which a force of about 10 kgf is applied to a center of an about 1 mm thick injection-molded specimen (about 50 mm×about 200 mm×about 1 mm) for 1 minute using the same analyzer as a flexural strength measuring apparatus in accordance with ASTM D790, followed by measuring a length change of the specimen. The polycarbonate resin composition may have a deformation length of about 16 mm or less, for example, from about 12 mm to about 16 mm, and as another example from about 14 mm to about 15.6 mm, as measured through the pressure deformation test. Within this range, the polycarbonate resin composition and a molded article thereof can exhibit excellent stiffness.

Further, to measure flexural properties of the polycarbonate resin composition, that is, anisotropy generated in an injection-molded article due to change in width (perpendicular direction to injection molding) and length (injection molding direction) of the molded article upon injection molding, a specimen having a width (perpendicular direction to injection molding)×length (injection molding direction)×thickness of about 5 cm×about 20 cm×about 1 mm is subjected to injection molding, and left for about 24 hours, thereby calculating a ratio of length/width after shrinkage. The polycarbonate resin composition may have a ratio of length/width after shrinkage from about 400.0 to about 405.5, for example, from about 401.0 to about 405.3. Here, when the specimen exhibits the same shrinkage in the longitudinal and transverse directions, the ratio of length/width is about 400 corresponding to the ratio of length/width of the initial specimen, and as the shrinkage in the transverse direction is further increased as compared with the shrinkage in the longitudinal direction, that is, as anisotropy is increased, the polycarbonate resin has a greater ratio of length/width.

Ratio of length/width after shrinkage=(Length after shrinkage/Width after shrinkage)×100 <Expression 1>

According to the present invention, a molded article is formed from the polycarbonate resin composition through various molding methods. Since the molded article can exhibit excellent stiffness, excellent impact resistance, excellent property balance therebetween, and the like, the molded article can be useful for interior/exterior materials and the like of electronics, automobiles and the like requiring both high stiffness and high impact properties, for example, extremely useful for electronics housings (thin exterior materials) having a thickness from about 0.4 mm to about 3.0 mm.

Hereinafter, the present invention will be described in more detail with reference to the following examples. It should be understood that these examples are provided for illustration only and are not to be construed in any way as limiting the present invention. A description of details apparent to those skilled in the art will be omitted for clarity.

### EXAMPLES

Details of components used in Examples and Comparative Examples are as follows:

(A) Polycarbonate Resin

Bisphenol-A polycarbonate (SC-1190G, Cheil Industries Inc., melt flow index (MI, measured at 300° C. under a load of 1.2 kg in accordance with ISO 1133): 20 g/10 min) is used.

(B) Inorganic Filler

(B1) Flake filler: Talc (KC-3000, KOCH Co., Ltd.) is used.

(B2) Flake filler: Mica (325-HK, Imerys Co., Ltd.) is used.

(B3) Acicular filler: Wollastonite (4 W, NYCO Co., Ltd.) is used.

(B4) Acicular filler: Potassium titanate whisker (TISMON, Otsuka Chemical Co., Ltd.) is used.

(C) Sulfonate

(C1) Sodium dodecylbenzenesulfonate (D0990, TCI Co., Ltd.) is used.

(C2) Potassium diphenylsulfonesulfonate (KSS, SLOSS Co., Ltd.) is used.

(D) Silane coupling agent

Decyltrimethoxysilane (KBM3103C, Shin-Etsu Chemical Co., Ltd.) is used.

### Examples 1 to 18 and Comparative Examples 1 to 17

The components are added in amounts as listed in Tables 2 to 7, respectively, followed by extrusion at 200° C. to 280° C., thereby preparing pellets. Here, acicular fillers are introduced into a side feeder and the others are introduced into a main feeder. Extrusion is performed using a twin-screw extruder having L/D=36 and a diameter of 45 mm. The prepared pellets are dried at 80° C. to 100° C. for 4 hours or more, followed by injection molding in a 6 oz injection machine (molding temperature: 280° C., mold temperature: 60° C.), thereby preparing specimens. Each of the prepared specimens is evaluated as to the following properties. Results are shown in Tables 2 to 7.

Evaluation of Properties

(1) Izod impact strength (unit: kgf·cm/cm): Izod impact strength is measured on a ⅛″ thick notched Izod specimen in accordance with ASTM D256.

(2) Falling dart impact (FDI) strength (unit: J): FDI strength is measured by measuring a height for generating a crack in a 1.0 mm thick specimen (10 cm×10 cm×1 mm) using a 2 kg dart in accordance with the Dupont drop measurement method, followed by converting the height into energy.

(3) Gas generation in gate surrounding portion: The pellets prepared in each of Examples and Comparative Examples are dried in an oven at 100° C. for 4 hours, followed by injection molding into a 1.0 mm thick specimen (10 cm×10 cm×1 mm) at an injection molding temperature of 280° C. and a mold temperature of 60° C. Next, the injection-molded specimen is observed to evaluate a degree of gas generation in a gate surrounding portion. Evaluation criteria of gas generation in the gate surrounding portion are shown in Table 1 (No gas generation: ⊚, Gas generation: O, Severe gas generation: X).

TABLE 1

| ⊚ | ◯ | X |
|---|---|---|
| [symbol] | [symbol] | [symbol] |

(4) Pressure deformation: Using the same analyzer as a flexural strength measuring apparatus in accordance with ASTM D790, a force of 10 kgf is applied to a center of a 1 mm thick injection-molded specimen (50 mm×200 mm×1 mm), followed by measuring a length change of the specimen.

(5) Anisotropy: To evaluate anisotropy (flexural properties), a specimen having a width (perpendicular direction to injection molding)×length (injection molding direction)×thickness of 50 mm×200 mm×1 mm is subjected to injection molding, and left for about 24 hours, thereby calculating a ratio of length/width after shrinkage according to Expression 1:

Ratio of length/width after shrinkage=(Length after shrinkage/Width after shrinkage)×100.

TABLE 2

| | | Example | | | | | |
|---|---|---|---|---|---|---|---|
| | | 1 | 2 | 3 | 4 | 5 | 6 |
| (A) (parts | | 100 | 100 | 100 | 100 | 100 | 100 |
| by weight) | | | | | | | |
| (B) | (B1) | 8 | 8 | 8 | 8 | — | — |
| (parts | (B2) | — | — | — | — | 8 | 8 |
| by | (B3) | 15 | 15 | — | — | 15 | 15 |
| weight) | (B4) | — | — | 15 | 15 | — | — |

| | | | | | | |
|---|---|---|---|---|---|---|
| (C1) (parts | 0.1 | 0.5 | 0.1 | 0.5 | 0.1 | 0.5 |
| by weight) | | | | | | |
| Izod impact | 5.5 | 7.0 | 5.0 | 7.0 | 6.0 | 7.5 |
| strength | | | | | | |
| FDI strength | 35 | 40 | 38 | 45 | 40 | 43 |
| Gas generation | ⊚ | ⊚ | ⊚ | ⊚ | ⊚ | ⊚ |
| Pressure | 15.55 | 15.50 | 14.95 | 14.90 | 15.00 | 15.00 |
| deformation | | | | | | |
| length (mm) | | | | | | |
| Ratio of | 405.25 | 405.2 | 405.14 | 405.14 | 405.27 | 405.2 |
| length/width | | | | | | |
| after shrinkage | | | | | | |

TABLE 3

| | | Example | | | | | |
|---|---|---|---|---|---|---|---|
| | | 7 | 8 | 9 | 10 | 11 | 12 |
| (A) (parts | | 100 | 100 | 100 | 100 | 100 | 100 |
| by weight) | | | | | | | |
| (B) | (B1) | 8 | 8 | 8 | 8 | — | — |
| (parts | (B2) | — | — | — | — | 8 | 8 |
| by | (B3) | 15 | 15 | — | — | 15 | 15 |
| weight) | (B4) | — | — | 15 | 15 | — | — |

| | | | | | | |
|---|---|---|---|---|---|---|
| (C1) (parts | 0.15 | 0.25 | 0.15 | 0.25 | 0.15 | 0.25 |
| by weight) | | | | | | |
| (D) (parts | 0.15 | 0.25 | 0.15 | 0.25 | 0.15 | 0.25 |
| by weight) | | | | | | |
| Izod impact | 6.0 | 7.5 | 5.3 | 8.0 | 6.7 | 8.0 |
| strength | | | | | | |
| FDI strength | 42 | 45 | 43 | 48 | 45 | 48 |
| Gas generation | ⊚ | ⊚ | ⊚ | ⊚ | ⊚ | ⊚ |
| Pressure | 15.53 | 15.51 | 14.45 | 14.78 | 14.80 | 14.80 |
| deformation | | | | | | |
| length (mm) | | | | | | |
| Ratio of | 405.20 | 405.15 | 405.15 | 405.12 | 405.12 | 405.17 |
| length/width | | | | | | |
| after shrinkage | | | | | | |

TABLE 4

| | | Example | | | | | |
|---|---|---|---|---|---|---|---|
| | | 13 | 14 | 15 | 16 | 17 | 18 |
| (A) (parts | | 100 | 100 | 100 | 100 | 100 | 100 |
| by weight) | | | | | | | |
| (B) | (B1) | 13 | 13 | 13 | 13 | — | — |
| (parts | (B2) | — | — | — | — | 13 | 13 |
| by | (B3) | 20 | 20 | — | — | 20 | 20 |
| weight) | (B4) | — | — | 20 | 20 | — | — |

| | | | | | | |
|---|---|---|---|---|---|---|
| (C1) (parts | 0.15 | 0.25 | 0.15 | 0.25 | 0.15 | 0.25 |
| by weight) | | | | | | |
| (D) (parts | 0.15 | 0.25 | 0.15 | 0.25 | 0.15 | 0.25 |
| by weight) | | | | | | |
| Izod impact | 7.6 | 9.5 | 7 | 9 | 8.1 | 11 |
| strength | | | | | | |
| FDI strength | 38 | 43 | 40 | 45 | 42 | 38 |
| Gas generation | ⊚ | ⊚ | ⊚ | ⊚ | ⊚ | ⊚ |
| Pressure | 14.36 | 14.35 | 14.11 | 14.10 | 14.20 | 14.21 |
| deformation | | | | | | |
| length (mm) | | | | | | |
| Ratio of | 405.15 | 405.14 | 405.14 | 405.12 | 405.15 | 405.14 |
| length/width | | | | | | |
| after shrinkage | | | | | | |

TABLE 5

| | | Comparative Example | | | | | | |
|---|---|---|---|---|---|---|---|---|
| | | 1 | 2 | 3 | 4 | 5 | 6 | 7 |
| (A) (parts | | 100 | 100 | 100 | 100 | 100 | 100 | 100 |
| by weight) | | | | | | | | |
| (B) | (B1) | 8 | 13 | 8 | 13 | 13 | 13 | 13 |
| (parts by | (B3) | 15 | 20 | 15 | 20 | 20 | 20 | 20 |
| weight) | | | | | | | | |

| | | | | | | | |
|---|---|---|---|---|---|---|---|
| (C1) (parts | — | — | — | — | — | 0.04 | 0.08 |
| by weight) | | | | | | | |
| (D) (parts | — | — | 0.1 | 0.1 | 0.5 | 0.04 | 0.08 |
| by weight) | | | | | | | |
| Izod impact | 4.0 | 4.8 | 4.5 | 5.2 | 6.0 | 4.5 | 4.3 |
| strength | | | | | | | |
| FDI strength | 1 | 1 | 9 | 5 | 10 | 1 | 1 |
| Gas generation | X | X | X | X | X | ◯ | ◯ |

TABLE 6

| | | Comparative Example | | | | | |
|---|---|---|---|---|---|---|---|
| | | 8 | 9 | 10 | 11 | 12 | 13 |
| (A) (parts | | 100 | 100 | 100 | 100 | 100 | 100 |
| by weight) | | | | | | | |
| (B) | (B1) | 33 | 33 | 33 | — | — | — |
| (parts | (B3) | — | — | — | 33 | 33 | 33 |
| by | | | | | | | |
| weight) | | | | | | | |

| | | | | | | |
|---|---|---|---|---|---|---|
| (C1) (parts | — | 0.15 | 0.25 | — | 0.15 | 0.25 |
| by weight) | | | | | | |
| (D) (parts | — | 0.15 | 0.25 | — | 0.15 | 0.25 |
| by weight) | | | | | | |
| Izod impact | 1.5 | 3 | 3.5 | 5 | 7 | 9 |
| strength | | | | | | |
| FDI strength | 1 | 17 | 20 | 1 | 15 | 16 |
| Gas generation | X | ◯ | ⊚ | X | ◯ | ⊚ |
| Pressure | 16.20 | 16.11 | 16.25 | 16.31 | 16.31 | 16.35 |
| deformation | | | | | | |
| length (mm) | | | | | | |
| Ratio of | 405.10 | 405.10 | 405.09 | 405.71 | 405.75 | 405.74 |
| length/width | | | | | | |
| after shrinkage | | | | | | |

TABLE 7

| | | Comparative Example | | | |
|---|---|---|---|---|---|
| | | 14 | 15 | 16 | 17 |
| (A) (parts by weight) | | 100 | 100 | 100 | 100 |
| (B) (parts | (B1) | 13 | 13 | 13 | 13 |
| by weight) | (B3) | 18 | 18 | 18 | 18 |

| | | | | |
|---|---|---|---|---|
| (C2) (parts by weight) | 0.04 | 0.15 | 0.25 | 0.5 |
| Izod impact strength | 4.0 | 3.5 | 3.0 | 3.0 |
| FDI strength | 7 | 8 | 10 | 11 |
| Gas generation | ◯ | X | X | X |

From the results, it can be seen that the polycarbonate resin compositions according to the present invention exhibit excellent properties in terms of impact strength (impact resistance), stiffness (pressure deformation), and gas generation.

Conversely, it can be seen that the polycarbonate resin compositions, which did not include the sulfonate and/or the silane coupling agent (Comparative Examples 1 to 5) or included the sulfonate in an amount of less than the amount according to the present invention (Comparative Examples 6 to 7), exhibit significant deterioration in impact resistance (particularly FDI strength) and suffer from severe gas generation in the gate surrounding portion. In addition, it can be seen that the polycarbonate resin compositions of Comparative Examples 8 to 10, which included the flake fillers alone, exhibit deterioration in stiffness and Izod impact strength, and that the polycarbonate resin composition, which did not include the sulfonate and the silane coupling agent, particularly suffer from severe gas generation in the gate surrounding portion and exhibit further deterioration in Izod impact strength. It can be seen that the polycarbonate resin compositions of Comparative Examples 11 to 13, which included the acicular fillers alone, exhibit deteriorated impact resistance and also exhibit deterioration in stiffness (pressure deformation) with increasing anisotropy (ratio of length/width after shrinkage).

In addition, it can be seen that the polycarbonate resin compositions including (C2) potassium diphenylsulfonesulfonate, which is generally used as a flame retardant, instead of the sulfonate according to the present invention (Comparative Examples 14 to 17) suffer from deterioration in appearance and the like due to gas generation in the gate surrounding portion upon injection molding, and exhibit deterioration in impact resistance and/or stiffness and thus low property balance therebetween.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims.

What is claimed is:

1. A polycarbonate resin composition comprising:
a polycarbonate resin;
inorganic fillers comprising flake and acicular fillers; and
a sulfonate represented by Formula 1,
wherein the sulfonate is present in an amount of about 0.1 parts by weight to about 1.0 part by weight based on about 100 parts by weight of the polycarbonate resin, 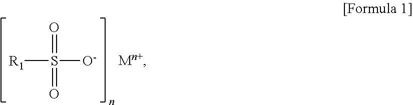
wherein R₁ is a C₆ to C₃₀ hydrocarbon group; M is an alkali or alkali earth metal; and n is 1 or 2.

2. The polycarbonate resin composition according to claim 1, wherein R₁ is a C₁₂ to C₁₈ hydrocarbon group and M is sodium (Na) or calcium (Ca).

3. The polycarbonate resin composition according to claim 1, wherein the flake fillers comprise talc, mica, or a mixture thereof; and the acicular fillers comprise wollastonite, whiskers, glass fibers, basalt fibers, or a mixture thereof.

4. The polycarbonate resin composition according to claim 1, wherein the flake fillers have an average thickness from about 30 nm to about 700 nm, an average particle size from about 0.65 μm to about 5.0 μm, and a ratio of an average diameter to the average thickness (diameter/thickness) from 4 to 30; and the acicular fillers have an average diameter (D) from about 0.3 μm to about 15 μm, an average length (L) from about 3 μm to about 3,000 μm, and a ratio of the average length to the average diameter (L/D) from about 10 to about 200.

5. The polycarbonate resin composition according to claim 1, comprising the inorganic fillers in an amount of about 1 part by weight to about 80 parts by weight based on about 100 parts by weight of the polycarbonate resin.

6. The polycarbonate resin composition according to claim 1, wherein the flake fillers are present in an amount of about 1 wt % to about 99 wt % based on a total amount of the inorganic fillers, and the acicular fillers are present in an amount of about 1 wt % to about 99 wt % based on the total amount of the inorganic fillers.

7. The polycarbonate resin composition according to claim 1, wherein a weight ratio of flake fillers to acicular fillers (flake fillers:acicular fillers) ranges from about 1:1 to about 1:2.

8. The polycarbonate resin composition according to claim 1, further comprising:
about 0.1 parts by weight to about 1.0 part by weight of a silane coupling agent based on about 100 parts by weight of the polycarbonate resin.

9. The polycarbonate resin composition according to claim 8, wherein the silane coupling agent is represented by Formula 2: 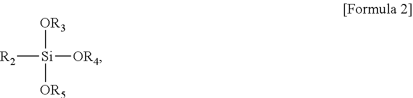
wherein R₂ is a C₆ to C₃₀ alkyl group, and R₃, R₄ and R₅ are the same or different and are each independently a C₁ to C₅ alkyl group.

10. The polycarbonate resin composition according to claim 8, wherein a content ratio of the sulfonate to the silane coupling agent (weight ratio, sulfonate:silane coupling agent) ranges from about 0.5:1 to about 1.5:1.

11. The polycarbonate resin composition according to claim 1, further comprising a flame retardant, flame retardant aid, lubricant, plasticizer, heat stabilizer, anti-dripping agent, antioxidant, photostabilizer, pigment, dye, or a mixture thereof.

12. The polycarbonate resin composition according to claim 1, wherein the polycarbonate resin composition has an Izod impact strength from about 5 kgf·cm/cm to about 16 kgf·cm/cm, as measured on an about ⅛″ thick specimen in accordance with ASTM D256, and a falling dart impact (FDI) strength from about 15 J to about 60 J, as measured on an about 3.2 mm thick specimen in accordance with the Dupont drop measurement method.

13. The polycarbonate resin composition according to claim 1, wherein the polycarbonate resin composition has a deformation length of 16 mm or less, as measured on an injection-molded specimen having a size of about 50 mm×about 200 mm×about 1 mm after a force of about 10 kgf is applied to a center of the injection-molded specimen for about 1 minute using the same analyzer as a flexural strength measuring apparatus in accordance with ASTM D790.

14. A molded article formed from the polycarbonate resin composition according to claim 1.

15. The molded article according to claim 14, wherein the molded article is an electronics housing having a thickness from about 0.4 mm to about 3.0 mm.
